(19) United States
(12) Patent Application Publication
(10) Pub. No.: US 2014/0012724 A1
(43) Pub. Date: Jan. 9, 2014

(54) AUTOMATED FRAUD DETECTION METHOD AND SYSTEM

(71) Applicants: Kevin O'leary, Drumcondra (IE); Johan Kaers, Heverlee (BE); David Dixon, Toronto (CA); Kilian Colleran, Churchtown (IE)

(72) Inventors: Kevin O'leary, Drumcondra (IE); Johan Kaers, Heverlee (BE); David Dixon, Toronto (CA); Kilian Colleran, Churchtown (IE)

(73) Assignee: DETICA PATENT LIMITED, DUBLIN (IE)

(21) Appl. No.: 14/006,788

(22) PCT Filed: Mar. 23, 2012
(86) PCT No.: PCT/EP12/55169

§ 371 Date: Sep. 23, 2013

Related U.S. Application Data
(60) Provisional application No. 61/466,558, filed on Mar. 23, 2011.

(30) Foreign Application Priority Data
Mar. 23, 2011 (IE) 2011/0133

(51) Int. Cl. G06Q 20/40

(52) U.S. Cl. CPC G06Q 20/4016
USPC 705/35

(57) ABSTRACT

A fraud detection method and apparatus are provided, arranged to:

(i) select a sample of entities, including at least one entity known to have been exposed to fraudulent activity or suspected of having been so exposed;
(ii) inputting, from an activity database, transaction data defining activity in respect of the sample of entities, the transaction data identifying associated information processing points;
(iii) processing the input transaction data to determine, using a predetermined set of metrics, evidence of compromise in any one or more of the identified information processing points; and
(iv) ranking the identified information processing points according to likelihood of compromise.

In this way, one or more information processing points may be identified as a potential source of fraud and steps triggered to identify, from the activity database, any other entities associated with those potential sources of fraud to prevent further fraud.

The invention relates to fraud detection in a variety of scenarios such as at processing points within a financial transaction process such as debit card or credit card transactions, cheque clearing, or electronic payments. It also applies to processes that do not involve the movement of money such as a call centre agent responding to a customer query.

A “mass data compromise” is the loss of a large number of records of a sensitive and commercially valuable nature through a deliberate act of fraud. Examples of mass data compromise include the theft of credit card numbers, social security numbers, online banking credentials or name and address information. Mass data compromise can occur in a process designed to move money, such as an ATM or point-of-sale (“POS”) card transaction, an online banking bill payment, or a wire transfer. It can also occur in a non-monetary back-office process such as account opening, a loan approval, or an account maintenance event such as change of address.

PCT/US/2006/025058 (FICO) describes a system for managing mass compromise of financial transaction devices is disclosed. A method includes maintaining a summary of a transaction history for a financial transaction device, and forming a device history profile based on the transaction history, the device history profile including predictive variables indicative of fraud associated with the financial transaction device.

U.S. Pat. No. 5,884,289 (Card Alert Services, Inc.) describes a debit card fraud detection and control system. This is a computer-based system that alerts financial institutions (“FIs”) to undetected multiple debit card fraud conditions in their debit card bases by scanning and analysing cardholder debit fraud information entered by financial institution (FI) participants. The result of this analysis is the possible identification of cardholders who have been defrauded but have not yet realised it, so they are “at risk” of additional fraudulent transactions.

U.S. Pat. No. 6,094,643 describes a system for detecting counterfeit financial card fraud in which counterfeit financial card fraud is detected based on the premise that the fraudulent activity will reflect itself in clustered groups of suspicious transactions.

U.S. Pat. No. 5,781,704 describes an expert system method of performing crime site analysis

### SUMMARY OF THE INVENTION

From a first aspect, the present invention resides in a fraud detection method, comprising the steps of:

(i) selecting a sample of entities, including at least one entity known to have been exposed to fraudulent activity or suspected of having been so exposed;
(ii) inputting, from an activity database, transaction data defining activity in respect of said sample of entities, the transaction data identifying associated information processing points;
(iii) processing said input transaction data to determine, using a predetermined set of metrics, evidence of compromise in any one or more of the identified information processing points; and
(iv) ranking the identified information processing points according to likelihood of compromise.

In a preferred embodiment step (iii) further comprises calculating, in respect of each of the identified information processing points, a feature vector having a plurality of attributes, each attribute representing a different metric in a set of metrics selected to provide, when evaluated, an indication of the likelihood of compromise of a respective information processing point relative to others of the identified information processing points.

In order to achieve a higher speed of analysis, the attributes of the feature vector for each information processing point are calculated incrementally using transaction data extracted from the activity database in respect of the information processing point and input as an ordered dataset, the value of each attribute at each increment being stored and updated in a shared memory store until all transaction data have been processed for the information processing point. In a further improvement, at step (iii), the calculation of feature vectors is carried out for each information processing point in parallel using a different instantiated processing thread for the calculation of each feature vector.

In a preferred ranking method, the ranking step (iv) comprises calculating a vector length for each of the feature vectors calculated in step (iii) and ranking the feature vectors, and hence the respective information processing points, in order of likelihood of compromise. In a refinement to this ranking method, calculating of the vector length further comprises applying a pre-processing step to a selected one or more of the attributes and using the results of the pre-processing step in the calculation of vector length. For example, the pre-processing step may include applying a predetermined weighting to the attributes of a feature vector according to the type of information processing point it represents prior to calculating the vector length.

Having identified one or more potential sources of fraud, the method further comprises the step:

(v) determining, from the activity database, the identity of one or more further entities, not included in the sample of entities, for which respective transaction data indicate an association with an information processing point identified in the ranking step (iv) as likely to have been compromised.

Optionally, techniques may be applied to prevent further fraud occurring, for example by adding the further step:

(vi) triggering an action to prevent fraud in respect of said one or more further entities identified at step (v).

One preferred example of such an action includes generating a containment message including a list of confirmed compromised information processing points.

The fraud detection method according to the present invention may be applied where the identified information processing points are of one or more types, including: people, such as agents in a call centre; physical transaction terminals and devices; and stages in a transaction-based business process. With different types of information processing point likely to be encountered, it is preferred that the application and weighting of feature vector attributes is configurable.

In order to detect potential sources of fraud, the set of metrics used in preferred embodiments of the present invention may comprise one or more metrics selected from: a frequency of usage by entities in the sample of entities at a respective information processing point; a frequency of usage by entities in the sample of entities at a respective information processing point in one or more predetermined time periods or categories of time period; a frequency of usage by entities in the sample of entities categorised by authorisation method where a respective information processing point supports different authorisation protocols; a frequency of usage by entities in the sample of entities that is relative to an independent reference entity population that does not include entities in the sample of entities; a total number of entities that interact with a respective information processing point; a time difference between earliest and latest times that entities in the sample of entities access a respective information processing point; a frequency of occurrence of a specific category of transaction; a time difference between successive transactions; a frequency of usage in respect of a particular host of an information processing point known to experience high transaction volumes; and a frequency of usage by entities in the sample of entities in respect of a host in a predetermined category of host.

In order to respond most directly to a detection of fraudulent activity, at step (i), selecting a sample of entities comprises selecting entities recorded in an incident database. An incident database may be maintained by an external agency and populated with details of known or suspected fraud incidents on financial entities such as credit cards. The contents of the incident database may be monitored or periodically accessed to trigger an application the fraud detection method of the present invention.

In order to improve the processing speed in the incremental calculation of attributes at step (iii), if A_{i,j} is the value of an attribute for a metric mᵢ in the set of metrics after processing an activity record xⱼ from the ordered dataset, and xⱼ₊₁ is the next activity record to be processed from the ordered dataset, then A_{i,j+1}=Fᵢ(A_{i,j},xⱼ₊₁) where Fᵢ is a function for incrementally evaluating the metric mᵢ. Thus, if the attribute values after each increment are stored in volatile rapid-access memory, then the speed of incremental calculation of feature vectors is improved

The method according to the present invention is particularly suited to determining a potential source of fraud in a mass data compromise event.

Preferably, at step (iv), in ranking the identified information processing points according to likelihood of compromise, an approval policy implemented as a set of rules is applied to exclude happenstance commonalities. Examples of such commonalities may be the widespread use of a utility company's online payment facility which is not itself suspected of compromise. At the other extreme, an information processing point may only be involved in transactions involving a very small subset of the sample of entities and therefore unlikely to be involved in a mass compromise event.

An iterative use may be made of preferred embodiments of the present fraud detection method, for example by adding the step:

(vii) using the results of step (iv) and step (v) to select a different subset of the activity database or to select a different sample of entities for use in a further execution of steps (i) to (iv) to search for further potential sources of fraud. In this way, the typically very large data sets may be analysed in an iterative way until a substantial proportion of the fraud risk has been assessed and diagnosed in a financial or equivalent transaction-based system.

From a second aspect, the present invention resides in a fraud detection apparatus comprising a digital processor arranged to implement a fraud detection method according to the first aspect of the present invention. To improve the speed of certain steps in the method implemented, the apparatus may further comprise hardware logic means arranged to implement one or more steps in the fraud detection method in hardware and to interact with the digital processor in a preferred implementation of the method.

From a third aspect, the present invention resides in a computer program product comprising a computer-readable medium having stored thereon software code means which when loaded and executed on a computer implement a fraud detection method according to the first aspect of the invention summarised above.

### DETAILED DESCRIPTION OF THE INVENTION

The invention will be more clearly understood from the following description of some embodiments thereof, given by way of example only with reference to the accompanying drawings in which:

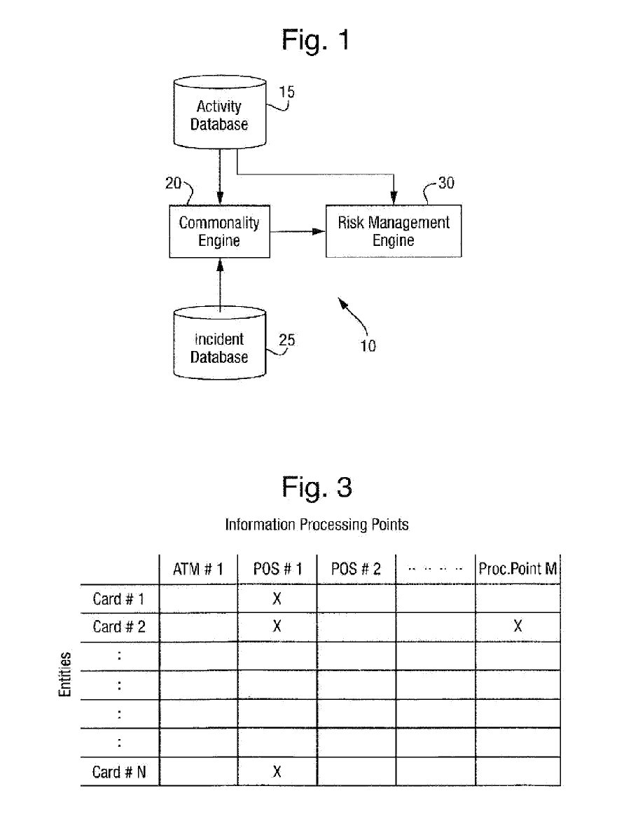

FIG. 1 is a functional block diagram for a fraud detection apparatus in a preferred embodiment of the present invention;

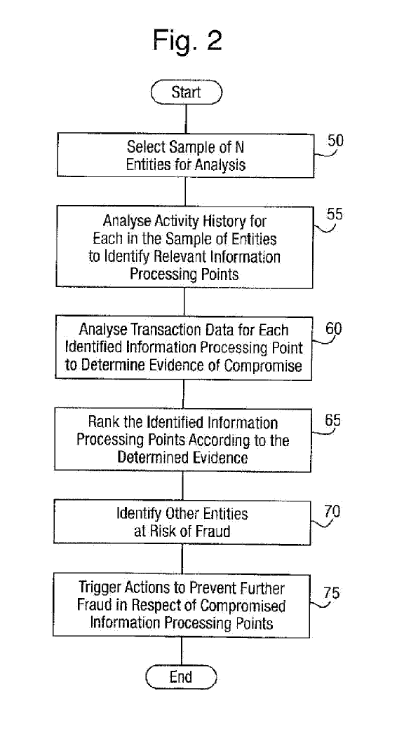

FIG. 2 is a high level flow diagram showing steps in operation of the fraud detection apparatus in a preferred embodiment of the present invention;

FIG. 3 is a table illustrating a correspondence between a selected sample of entities and information processing points identified in transactions on the sample of entities;

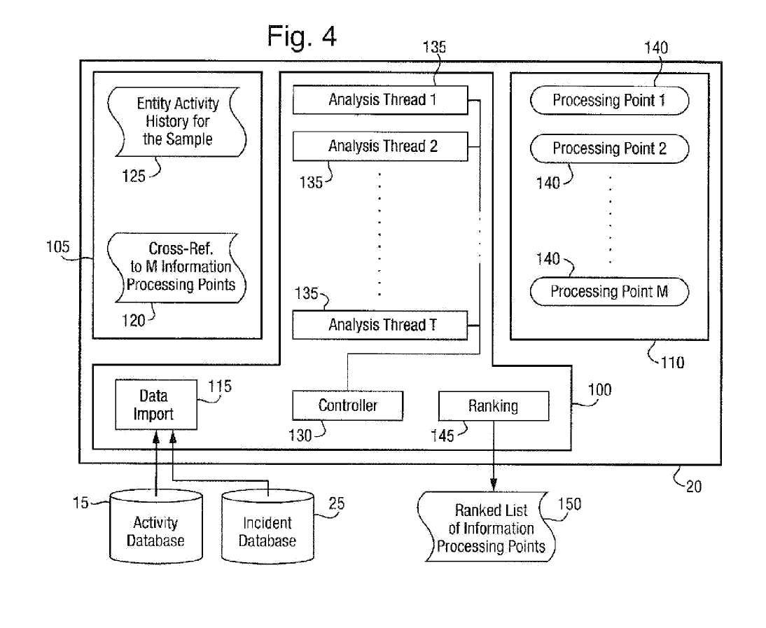

FIG. 4 is a functional block diagram for a commonality engine in a preferred embodiment of the fraud detection apparatus of the present invention; and

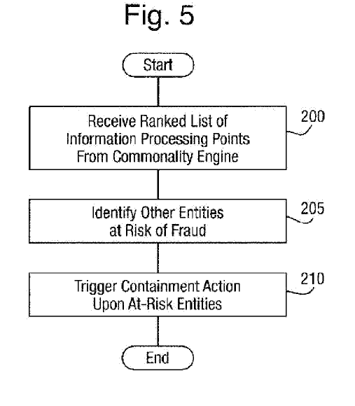

FIG. 5 is a high level flow diagram showing steps in operation of a risk management engine in a preferred embodiment of the present invention.

In complex transaction-based systems involving data flows between multiple different processing points and combinations of processing points, the impact of a fault or other form of compromise in any one of those multiple processing points can be experienced by multiple different entities for whom transactions have been, are being or may in future be handled by that processing point.

In financial systems, for example, any fraudulent compromise in a particular processing point, such as a teller machine, can affect multiple users if fraudulent data capture enables a fraudster to generate fraudulent transactions in respect of those users. It may be that the only symptom of a fraudulent compromise having taken place is the identification of unexpected transactions at some variable time in the future. There is a need to be able to trace events back to identify a potential source of the observed fraud sufficiently quickly to be able to prevent further losses. However, the potentially vast quantities of transaction data generated since the original source of the fraud and the difficulties in recognising a potential source of fraud in such data limits the speed of response.

Staying with the financial example, a purchase involving a credit card may begin with a point of sale terminal at which the card is presented by a customer. The sale transaction passes through the IT systems of the respective merchant, then to the merchant's acquiring bank and payment processor, before being referred to the bank that issued the card for authorisation of a payment transaction. Similarly, a change of address request in respect of a particular bank account, made by the account holder through a call centre agent, may pass from the agent's desktop workstation through a call centre web application to a core banking system where an update to the account holder's address information takes place. Each discrete element involved in such a process will be referred to in the present patent application as an ‘information processing point’. An information processing point in a financial system may include, amongst other types: a piece of hardware such as an automated teller machine (ATM); a point-of-sale terminal; a virtual location identified by an IP address; a network port specified by a MAC address; a corporate entity such as a merchant, agent or payment processor; and a human entity such as bank employee, bank teller or broker. However, in principle, an information processing point may be any element of a transaction processing system that is likely to be involved in handling data relating to different transactions or information flows.

Similarly, for the purposes of the present patent application, transactions are generated in respect of one or more “entities”. An “entity” is intended to include any device or enabling means whose use or recognition at an information processing point results in transaction data being generated in a system. In the financial systems example, an “entity” may include a credit card, a debit card issued in respect of a bank account, an insurance policy, or any such financial instrument that may be used to initiate or enable completion of a financial transaction. A person of ordinary skill would readily recognise other examples of “entities” in financial and other types of transaction-based system.

Of particular interest in the present invention, a mass data compromise event occurs when a specific “information processing point” is manipulated or compromised. For example, in addition to performing its normal function, it also stores a copy of the data that flows through it, eventually forwarding that stored information to an external agent for the purposes of committing fraud. Alternatively, the information processing point may make fraudulent alterations to data. A point of sale terminal may be compromised so that in addition to facilitating a purchase with a credit card, it also keeps a copy of the card number, expiration date, personal identification number (PIN) or security code which is forwarded to a fraudster over a wireless connection. In another scenario, a bank employee may copy information about bank accounts and sell that information to fraudsters.

A mass data compromise event remains undiscovered until the stolen information is used for malicious purposes, such as committing fraud. For example, the stolen data may be used to gain access to bank accounts, create cloned credit or debit cards, apply for loans under false pretences or other form of attack for financial gain.

Given that mass data compromise can affect large numbers of entities in a short space of time, it is important to be able to detect one or more sources of compromise and prevent further use of stolen information. In a preferred embodiment of the present invention applied to the detection of fraud in financial systems, this detection and prevention capability may be implemented as a multi-step process by a preferred fraud detection apparatus as will now be described, firstly with reference to FIG. 1.

Referring to FIG. 1, a functional block diagram is presented showing top level functional components in a fraud detection apparatus 10. An activity database 15 contains a collated historical record of transactions relating to entities used in a financial system. Typically, the activity database may contain records of all financial transactions relating to entities such as bank accounts or credit card accounts of a particular bank over a defined time period, or transactions relating to insurance policies brokered by a particular insurance company. The activity database may extend to multiple financial institutions and any manageable time period, but in view of the potentially vast quantities of data involved a more structured database may be preferred. A commonality engine 20 is arranged with access to the activity database 15 to analyse historical transaction records in respect of a sample of entities and to look for features in common within those records as evidence of compromise. The commonality engine 20 is arranged with access to an incident database 25 containing identifiers of entities known or suspected as having been subjected to fraud and thereby selects the sample of entities for analysis to include some or all of the entities identified in the incident database 25. Common features sought by the commonality engine 20 include information processing points in common. A risk management engine 30 is arranged to act upon any results of analysis by the commonality engine 20 to prevent further fraud in respect of a detected compromise.

Preferably, the activity database 15 is collated and made available to the fraud detection system 10 by external agencies. Its creation and update is not intended to be a function of the fraud detection system 10 of the present invention. Similarly, the incident database 25 preferably contains data generated by one or more external agencies, for example those operating network level fraud detection engines designed to look for evidence of fraudulent activity in data using various behavioural and other metrics. Such agencies would, for example, detect a sudden increase in transaction activity performed on a credit card inconsistent with normal behaviour, suggesting that the credit card had been cloned.

Transaction data will typically be generated and recorded by or in respect of an information processing point. So, for example, a teller machine may record details of that part of an end-to-end transaction involving the teller machine. It will be assumed that an agency providing the activity database 15 is responsible for the capture of transaction records from each respective information processing point and the collation of records such that all transactions relating to a particular entity may be identified. Preferably, transaction records generated in respect of an information processing point contain: a unique identifier for the transaction as handled by the information processing point; an identifier for the information processing point; an identifier for the transacting entity; a date and time of the transaction; any verification or authorisation method or protocol used; quantitative data relating to the transaction, such as a value of the transaction; and, where appropriate, data identifying any related party, such as the merchant hosting the information processing point or other intended beneficiary in the transaction. The activity database 15 may contain the raw transaction records for each information processing point, indexed by the identifier for the respective transacting entities, or it may contain a set of transaction records in which end-to-end transactions in respect of each entity are collated such that all the information processing points involved in each transaction may be readily identified, together with associated data.

To summarise a preferred multi-step process implemented by the fraud detection system 10, reference will now be made additionally to FIG. 2.

Referring to FIG. 2, a flow diagram shows a top-level series of steps, beginning at STEP 50 with the selection of a sample of N entities for which fraud is known or suspected and on which to carry out further analysis. Preferably such a sample of entities is selected from those identified in an incident database 25. At STEP 55, the commonality engine 20 extracts the transaction history (15) for each in the selected sample of N entities from the activity database 15 to identify the M information processing points involved in transactions for the N entities. At STEP 60, the commonality engine 20 analyses the transaction history for each of the M identified information processing points to determine evidence of compromise using a number of predetermined metrics which, when considered together enable, at STEP 65, a ranking of the information processing points according to likelihood of compromise. The commonality engine 20 having determined the information processing point or points most likely to have been compromised, the risk management engine 30 then analyses, at STEP 70, the transaction history (e.g. from the activity database 15) of the selected information processing point or points to identify any other entities potentially at risk of fraud but which were not previously identified in the sample of N entities. Any necessary action would then be taken at STEP 75 to prevent further fraud, for example by blocking further use of those identified entities and taking action in respect of the compromised information processing point or points.

For example, in the case of known or suspected card fraud, the process outlined above would attempt to discover the unique identifier of a compromised point-of-sale (PoS) terminal used to capture security data from a number of credit cards, to search for any other credit cards that used the terminal within a specified time period and block further usage of those cards before issuing new cards. In the case of online banking, the process would attempt to identify an IP address or device fingerprint associated with a data loss event and then block access to other accounts that are associated with the same IP address and device fingerprint before resetting passwords.

In the selection of a sample of N entities at STEP 50, it is preferred that those N entities are known to have experienced fraudulent activity, or are suspected of having done so. In general, by focussing on the information processing points involved in transactions in respect of such entities, it is more likely that a source of fraud in the form of a compromised information processing point will be found. However, the preferred metrics for identifying evidence of compromise, as will be described in more detail below, would be useable in a larger sample of N entities, including entities not currently suspected of being subject to fraudulent activity. However, given the potentially large values of N (number of entities in the sample) and M (number of different information processing points involved) and the large number of historical transactions likely to require analysis, the availability of processing capability will determine the size of sample N that may be analysed in a reasonable time. While it is preferred that the sample be comprised solely of entities known or suspected as having experienced fraud, as listed in an incident database 25, the sample may alternatively be comprised in part or entirely of entities selected at random or specifically targeted for other reasons (e.g. cards issued by a specific bank, or bank accounts associated with addresses in a selected geographic area), from the activity database 15 or other sources. In an extreme example, the sample may be comprised entirely of N entities selected from the activity database 15 according to any of a variety of selection criteria as would be apparent to a person of ordinary skill in the relevant art.

The result of analysis at STEP 55 by the commonality engine 20, to identify the M information processing points involved in transactions for the sample of N entities, may be represented as a table of cross-references—an N×M matrix. FIG. 3 shows such a table of cross-references for a particular example where a sample of N credit cards forms the basis of the analysis and M information processing points such as automatic teller machines (ATMs) and retail PoS terminals have been identified from corresponding activity data (15). N and M can be very large numbers; of the order of tens of thousands for example.

Having identified the M information processing points, the analysis of transaction data at STEP 60 to look for evidence of compromise involves the calculation, for each information processing point, of a predetermined set of metrics which when considered together with appropriate weightings enable a relative likelihood of compromise to be calculated, at STEP 65, and the M information processing points to be ranked according to decreasing likelihood of compromise. It is the evaluation of metrics and the ranking of the information processing points in this process that requires potentially the greatest processing effort, given that N and M may be large numbers and the analysis is of N×M order of magnitude. A preferred process and architecture by which the commonality engine 20 carries out the processing in STEP 60 and STEP 65 very rapidly will now be described in more detail with particular reference to FIG. 4.

Referring to FIG. 4, a functional block diagram of the commonality engine 20 is shown in which a digital processor 100 is provided with access to a data import cache 105 and a shared memory 110. Using a sample of N entities selected from an incident database 25, a data import module 115 executes on the digital processor 100 to generate a cross-referenced table or N×M matrix 120, of a form discussed above with reference to FIG. 3, identifying the M information processing points to be analysed for potential compromise in respect of the selected sample of N entities. The cross-referenced data 120 are stored in the data import cache 105.

Given the M identified information processing points (120), the data import module 115 is further arranged to read transaction data from the activity database 15 into the data import cache 105, extracting the historical activity of each of the N entities in the sample. For example, in a financial system, the historical activity of a single entity may include all financial transactions conducted through one bank account, or all non-financial events including actions carried out by bank employees, or all payments processed by one card. The data import module 115 then sorts the extracted historical activity records by the unique identifier of the information processing point to form an ordered dataset 125 which it stores in the data import cache 105. For example, card transactions are sorted by PoS terminal identifier, and online banking transactions are sorted by IP address. This sorting ensures that records related to each information processing point may be processed in an ordered sequence, so ensuring that various caching mechanisms built into the otherwise conventional database access software, disk driver, operating system and CPU's of the commonality engine 20 are most efficiently utilised.

The sorted activity records 125 are input to the digital processor 100 as an ordered stream of records, for example ordered by date and time or in another order most suited to a need for rapid calculations, as follow. A controller module 130 executes on the digital processor 100 to instantiate a new analysis thread 135 each time a different information processing point is identified in the input data stream. The newly instantiated analysis thread 135 performs an analysis of the records for that particular information processing point. These analyses comprise the calculation of a feature vector 140 for each of the M identified information processing points from data contained in the activity records 125. The feature vectors 140 are stored in the shared memory 110, one feature vector 140 for each information processing point. Each attribute in the feature vector 140 is a value for a different predetermined metric, calculated for the respective information processing point using data contained in the input activity records 125 or obtainable from other data sources, as appropriate. The metrics are chosen for their relevance, whether individually or in combination, to the determination of whether an information point has been compromised. Each analysis thread 135, upon first reading of data from the input activity records 125 for a particular information processing point, instantiates an object in the shared memory 110 for that information processing point using initial values for each of the metrics, and then, upon receiving each subsequent activity record, updates the relevant metric attributes in the feature vector 140 until all are processed for that information processing point. A relevant ordering of the activity records 125 in the input dataset can thus be helpful in achieving a rapid evaluation of such metrics, as would be apparent to a person of ordinary skill in the relevant art. This process may be performed very quickly as each analysis thread 135 manipulates and updates data stored in memory rather than on disk.

As the data stream 125 read from the data import cache 105 is expected to arrive within the processor 100 faster than a given analysis thread 135 is able to generate the feature vector 140 for a given information processing point, new analysis threads 135 are continuously instantiated by the controller module 130 so that parallel processing of the data stream 125 takes place. The number of parallel threads 135 would be expected to increase gradually as the data stream is received, but the overall process scales automatically according to the rate of data input, the number of activity records to be processed for each information processing point, and the number and complexity of metrics to be evaluated in generating a feature vector 140. By these means, the highest possible processing speeds are maintained until all the activity records 125 are analysed.

The attributes comprised in each feature vector 140 are calculated incrementally as each new activity record is received. For example, if A_{i,j} is the value of an attribute for the metric mᵢ after processing activity record xⱼ, and xⱼ₊₁ is the next activity record to be processed, then A_{i,j+1}=Fᵢ(A_{i,j},xⱼ₊₁) where Fᵢ is the function for incrementally evaluating the metric mᵢ. This aspect of the invention maximises the speed at which the commonality engine 20 executes because the values A_{i,j} are cached in the shared memory 110. Thus, the present invention provides an advantageous improvement in speed when compared to an alternative performance-intensive aggregation computation procedure involving repeated queries of the activity database 15, such as may be performed using SQL queries in a conventional relational database. In that case, the updated value A_{i,j+1} would only be found by repeated calls to the database to retrieve historical records, i.e. A_{i,j+1}=Gᵢ(x₁, x₂, x₃ . . . xⱼ xⱼ₊₁) where Gᵢ is a function to compute the value for the metric mᵢ.

A different set of metrics may be applied to each type of information processing point, or a common set of metrics may be evaluated but with a different set of weightings being applied by the commonality engine 20 in the ranking STEP 65, according to the type of information processing point. Thus the selection of metrics and the weightings applied are configurable.

In an application of the fraud detection apparatus directed to looking for sources of credit or debit card fraud in a financial system, a preferred set of metrics for use in constructing a feature vector for a particular information processing point may include the following:

frequency of usage by cards in the sample set of N cards;
frequency of usage by cards in the sample set of N cards in particular time-slots during a 24 hour day;
frequency of usage by cards in the sample set of N cards on specific days of the week;
frequency of usage by cards in the sample set of N cards on specified days of the year such as notable holidays;
frequency of usage by cards in the sample set of N cards categorised by authorisation method where the information processing point supports different authorisation protocols;
frequency of usage by cards in the sample set of N cards that is relative to an independent reference entity population that does not include the N cards in the sample;
total number of cards that interact with the particular information processing point;
time difference between the earliest and latest times that cards access the particular information processing point;
frequency of specific types of financial transactions such as low-value transactions, sometimes referred to as test transactions;
time difference between test transactions and subsequent high-value suspicious transactions;
frequency of usage at merchants which are known to have high transaction volumes;
frequency of usage at merchants with a specific merchant category code.

Of course entities other than cards (bank debit or credit cards) may be In other fields of application, a set of metrics may be devised to look for evidence of compromise or failure in equivalent information processing points, as would be apparent to a person of ordinary skill in the relevant field.

In the case of credit card fraud for example, a simple feature vector 140 may comprise attributes of four metrics: number of entities encountered; number of records per entity; time of first encounter with one of the sample entities; time of last encounter with one of the sample entities. The vector 140 provides a concise summary of the interaction between each processing point and all of the entities it encountered.

Having completed the analysis of the activity records 125, the shared memory 110 contains a feature vector 140 evaluated by a respective analysis thread 135 for each of the M information processing points. A ranking module 145 executes on the digital processor 145 to implement STEP 65 by means of a ranking algorithm designed to determine the relative likelihood of compromise among the M information processing points. The ranking algorithm may be more or less sophisticated according to whether particular rules or other information sources are to be considered in applying a weighting to certain of the attributes in the feature vectors 140.

In a relatively simple ranking algorithm, the ranking module 145 is arranged to calculate the length of each feature vector 140 and to generate a list of the M information processing points ordered by decreasing feature vector length. If necessary, some pre-processing of particular attributes in a feature vector may be carried out, for example: to evaluate date ranges as a number of days; to calculate the reciprocal of an attribute value; or to apply a predetermined or configurable set of weightings to the attributes according to the type of information processing point. The ranking module 145 may thereby generate a list 150 of information processing points ranked according to decreasing likelihood of having been compromised, in particular of having been a source of fraud in respect of some or all of the sample of N entities. Such a ranking process is non-parametric. Non-parametric evaluation of metrics requires no training based on prior incidents and is configurable to capture different behaviours at information processing points.

Preferably, one or more sets of weightings may be derived from an offline training phase involving transaction data (15) captured at information processing points known to have been compromised and known not to have been compromised, using a conventional learning algorithm. Furthermore, during operation of the fraud detection apparatus 10, the set or sets of weightings may be updated dynamically using feedback on the results of the ranking step 65 to vary certain weighting values so that the likelihood that compromised information processing points will be ranked highly is increased.

For example, in a card skimming case, the ranking algorithm will comprise a multiple sort, firstly according to data range (lowest ranking highest), then according to number of entities (i.e. cards) encountered (highest ranking highest) and finally according to average number of activity records per entity (i.e. transactions per card) (with lowest ranking highest). The logic for this case being that those processing points (i.e. points of sale) that were used for a limited time are most likely to indicate a fraudulent activity, especially if the number of unique cards is high (rank 2) and if the average number of transactions is low (rank 3).

However, in the case of call centre fraud the relative ranking would differ to capture differing fraudulent behaviour. The relative ranking for scoring purposes is configurable.

To improve the performance of the metrics in revealing potential compromise amongst information processing points, certain data may be identified and either eliminated or its weighting altered in the feature vector ranking calculations at STEP 65. For example, if certain information processing points are known not to have been compromised, but they have been involved in transactions common to a number of entities in the sample and so likely to be ranked more highly through that commonality, then they may be eliminated from the calculations at STEP 65. This ensures that their high ranking does not distract attention away from other information processing points more likely to have been compromised. For example, where account holders may all have paid bills to the same utility company, this would be a happenstance commonality, which is not suspicious. Similarly, it may be usual for certain information processing points to experience high transaction volumes, even among entities in the sample, and their inclusion in the ranking may distract from other potential sources of fraud. Preferably, a rule set may be applied to the determination of which information processing points to eliminate from the ranking calculations, if necessary with reference to a maintained source of information about the status of certain information processing points, e.g. those already eliminated from suspicion of compromise. For example, the rule set may include a rule to exclude information processing points common to 3 or fewer entities.

The ranked list of information processing points 150 is passed to a risk management engine to implement STEP 70 and STEP 75 in the process described above with reference to FIG. 2. The functionality of a risk management engine 30 in a preferred embodiment of the present invention will now be described with reference to FIG. 5.

Referring to FIG. 5, a flow diagram shows the steps in operation of the risk management engine 30, in particular to determine what action to take in response to a possible mass data compromise event. The ranked list 150 of information processing points is received at STEP 200 from the commonality engine 20 and used at STEP 205 to identify other entities at risk of fraud, not included in the sample of N entities. This may be achieved by analysing transaction data in the activity database 15 to identify those entities that may have been exposed to one or more of the most highly ranked information processing points (150). For example, searching bank account activity may reveal many other bank accounts which have been accessed by the same call centre agent. These accounts should be considered at risk of experiencing fraud at some future date.

The final step in operation of the risk management engine 30 is an action step, STEP 210, to generate and send a message to an external agency to trigger containment action upon at-risk entities. For example, the risk management engine 30 may notify a core banking system to block access to a list of bank accounts identified in STEP 205.

The fraud detection apparatus of the present invention may be used to apply an iterative search for potential sources of fraud. For example, in a first round of analysis, highest priority may be given to a search for a source of fraud involving a sample of entities known to have experienced fraud. A ranked assessment (150) of respective information processing points will be generated and hopefully one or more sources of fraud will have been identified from that ranked list. The option then exists to make a new extraction of transaction data from the activity database 15 which takes account of the fact that certain information processing points have already been assessed. There are numerous ways in which the datasets involved in a second round of analysis may be reduced of a second-order sample of entities may be selected in order to lighten the data processing load at each subsequent round of analysis.

In one example, any transaction record relating to an end-to-end transaction in which one of the known compromised information processing points is involved may be eliminated from a second round of analysis, so that only a subset of the activity database 15 is used with a new sample of N entities. Alternatively, given a knowledge, from STEP 65, of which information processing points are known to have been compromised and a knowledge, from STEP 70 (205), of which entities may have been exposed to risk of fraud from those compromised information processing points, a new sample of N entities may be chosen that includes neither those entities identified in STEP 70 nor those included in the original sample of N entities from STEP 50 in the previous round (or rounds) of analysis.

The invention is not limited to the embodiments specifically described above, but may be varied in construction and detail without departing from key elements of the present invention. For example, certain elements of the fraud detection apparatus may be implemented entirely in software executing on a digital processor. However, in order to increase the speed of execution of certain high-demand functions, they may be implemented in hardware using field-programmable gate arrays (FPGAs) or equivalent hardware devices. Furthermore, the databases described need not necessarily be discrete, but may be integrated together, or with other databases, optionally located with and managed by external agencies.

1. A fraud detection method, comprising the steps of:
(i) selecting a sample of entities, including at least one entity known to have been exposed to fraudulent activity or suspected of having been so exposed;
(ii) inputting, from an activity database, transaction data defining activity in respect of said sample of entities, the transaction data identifying associated information processing points;
(iii) processing said input transaction data to determine, using a predetermined set of metrics, evidence of compromise in any one or more of the identified information processing points; and
(iv) ranking the identified information processing points according to likelihood of compromise to thereby identify a potential source of fraudulent activity.

2. The method according to claim 1, wherein step (iii) further comprises calculating, in respect of each of the identified information processing points, a feature vector having a plurality of attributes, each attribute representing a different metric in a set of metrics selected to provide, when evaluated, an indication of the likelihood of compromise of a respective information processing point relative to others of the identified information processing points.

3. The method according to claim 2, wherein the attributes of the feature vector for each information processing point are calculated incrementally using transaction data extracted from the activity database in respect of the information processing point and input as an ordered dataset, the value of each attribute at each increment being stored and updated in a shared memory store until all transaction data have been processed for the information processing point.

4. The method according to claim 3, wherein at step (iii) the calculation of feature vectors is carried out for each information processing point in parallel using a different instantiated processing thread for the calculation of each feature vector.

5. The method according to claim 2, wherein the ranking step (iv) comprises calculating a vector length for each of the feature vectors calculated in step (iii) and ranking the feature vectors, and hence the respective information processing points, in order of likelihood of compromise.

6. The method according to claim 5, wherein calculating of the vector length further comprises applying a pre-processing step to a selected one or more of the attributes and using the results of the pre-processing step in the calculation of vector length.

7. The method according to claim 6, wherein the pre-processing step includes applying a predetermined weighting to the attributes of a feature vector according to the type of information processing point it represents prior to calculating the vector length.

8. The method according to claim 1, further comprising the step:
(v) determining, from the activity database, the identity of one or more further entities, not included in the sample of entities, for which respective transaction data indicate an association with an information processing point identified in the ranking step (iv) as likely to have been a source of fraudulent activity.

9. The method according to claim 8, further comprising the step:
(vi) triggering an action to prevent fraud in respect of said one or more further entities identified at step (v).

10. The method according to claim 9 wherein, at step (vi), triggering an action comprises generating a containment message including a list of confirmed compromised information processing points.

11. The method according to claim 1, wherein the identified information processing points are of one or more types, including: people, such as agents in a call centre; physical transaction terminals and devices; and stages in a transaction-based business process.

12. The method according to claim 7, wherein the application and weighting of feature vector attributes is configurable.

13. The method according to claim 2, wherein the set of metrics comprise one or more metrics selected from: a frequency of usage by entities in the sample of entities at a respective information processing point; a frequency of usage by entities in the sample of entities at a respective information processing point in one or more predetermined time periods or categories of time period; a frequency of usage by entities in the sample of entities categorised by authorisation method where a respective information processing point supports different authorisation protocols; a frequency of usage by entities in the sample of entities that is relative to an independent reference entity population that does not include entities in the sample of entities; a total number of entities that interact with a respective information processing point; a time difference between earliest and latest times that entities in the sample of entities access a respective information processing point; a frequency of occurrence of a specific category of transaction; a time difference between successive transactions; a frequency of usage in respect of a particular host of an information processing point known to experience high transaction volumes; and a frequency of usage by entities in the sample of entities in respect of a host in a predetermined category of host.

14. The method according to claim 1, wherein at step (i), selecting a sample of entities comprises selecting entities recorded in an incident database.

15. The method according to claim 3 wherein, in the incremental calculation of attributes, if A_{i,j} is the value of an attribute for a metric mᵢ in the set of metrics after processing an activity record xⱼ from the ordered dataset, and xⱼ₊₁ is the next activity record to be processed from the ordered dataset, then A_{i,j+1}=Fᵢ(A_{i,j},xⱼ₊₁) where Fᵢ is a function for incrementally evaluating the metric mᵢ.

16. The method according to claim 1, directed to determining a potential source of fraud in a mass data compromise event.

17. The method according to claim 1 wherein, at step (iv), in ranking the identified information processing points according to likelihood of compromise, an approval policy implemented as a set of rules is applied to exclude happenstance commonalities.

18. The method according to claim 9, further comprising the step:
(vii) using the results of step (iv) and step (v) to select a different subset of the activity database or to select a different sample of entities for use in a further execution of steps (i) to (iv) to search for further potential sources of fraud.

19. A fraud detection apparatus comprising a digital processor arranged to implement a fraud detection method according to claim 1.

20. The fraud detection apparatus according to claim 19, further comprising hardware logic means arranged to implement one or more steps in the fraud detection method in hardware and to interact with the digital processor in an implementation of the method.

21. A computer program product comprising a computer-readable medium having stored thereon software code means which when loaded and executed on a computer implement a fraud detection method according to claim 1.
